(19) United States
(12) Patent Application Publication
(10) Pub. No.: US 2023/0394136 A1
(43) Pub. Date: Dec. 7, 2023

(54) SYSTEM AND METHOD FOR DEVICE ATTRIBUTE IDENTIFICATION BASED ON QUERIES OF INTEREST

(71) Applicant: Armis Security Ltd., Tel Aviv-Yafo (IL)

(72) Inventors: Ron SHOHAM, Tel Aviv (IL); Tom HANETZ, Tel Aviv (IL); Yuval FRIEDLANDER, Petah-Tiqwa (IL); Gil BEN ZVI, Hod Hasharon (IL)

(73) Assignee: Armis Security Ltd., Tel Aviv-Yafo (IL)

(21) Appl. No.: 17/804,885

(22) Filed: Jun. 1, 2022

(51) Int. Cl. G06F 21/55; G06F 21/44

(52) U.S. Cl. CPC G06F 21/552; G06F 2221/034; G06F 2221/2129; G06F 21/44

(57) ABSTRACT

A system and method for determining device attributes based on host configuration protocols. A method includes identifying queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data; determining prediction thresholds by applying the machine learning model to a validation data set, wherein each prediction threshold corresponds to a respective output of the machine learning model; and determining, based on the prediction thresholds and the scores output by the machine learning model for the identified queries of interest when applied to the application dataset, device attributes for the device.

### TECHNICAL FIELD

The present disclosure relates generally to identifying device attributes such as operating system for use in cybersecurity for network environments, and more specifically to identifying device attributes using queries of interest in requests such as Domain Name System (DNS) requests.

### BACKGROUND

Cybersecurity is the protection of information systems from theft or damage to the hardware, to the software, and to the information stored in them, as well as from disruption or misdirection of the services such systems provide. Cybersecurity is now a major concern for virtually any organization, from business enterprises to government institutions. Hackers and other attackers attempt to exploit any vulnerability in the infrastructure, hardware, or software of the organization to execute a cyber-attack. There are additional cybersecurity challenges due to high demand for employees or other users of network systems to bring their own devices, the dangers of which may not be easily recognizable.

To protect networked systems against malicious entities accessing the network, some existing solutions attempt to profile devices accessing the network. Such profiling may be helpful for detecting anomalous activity and for determining which cybersecurity mitigation actions are needed for activity of a given device. Providing accurate profiling is a critical challenge to ensuring that appropriate mitigation actions are taken.

The challenge involved with profiling a user device is magnified by the fact there is no industry standard for querying or obtaining information from user devices. This challenge is particularly relevant when attempting to determine device attributes. As new types of devices come out frequently and there is not a single uniform standard for determining device attributes in data sent from these devices, identifying the attributes of devices accessing a network environment is virtually impossible.

More specifically, as device data is obtained from various sources, device attributes such as operating system may be absent or conflicting in data from the various sources.

For example, this may be caused by partial visibility over network traffic data due to deployment considerations, partial coverage due to sampled traffic data as opposed to continuously collected traffic data, continuous and incremental collection of device data over time, and conflicting data coming from different sources.

The traffic data available between clients and servers may contain demands for information in the forms of requests. An example of such a request is a Domain Name System (DNS) request, which is a demand for information sent from a DNS client to a DNS server. A DNS request may be sent, for example, to ask for an Internet Protocol (IP) address associated with a domain name.

Solutions for ensuring complete and accurate device attribute data are therefore highly desirable.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining device attributes based on queries of interest. The method comprises: identifying a plurality of queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data; determining a plurality of prediction thresholds by applying the machine learning model to a validation data set, wherein each prediction threshold corresponds to a respective output of the machine learning model; and determining, based on the plurality of prediction thresholds and the at least one score output by the machine learning model for the identified queries of interest when applied to the application dataset, at least one device attribute for the device.

Certain embodiments disclosed herein also include a non-transitory computer readable medium having stored thereon causing a processing circuitry to execute a process, the process comprising: identifying a plurality of queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data; determining a plurality of prediction thresholds by applying the machine learning model to a validation data set, wherein each prediction threshold corresponds to a respective output of the machine learning model; and determining, based on the plurality of prediction thresholds and the at least one score output by the machine learning model for the identified queries of interest when applied to the application dataset, at least one device attribute for the device.

Certain embodiments disclosed herein also include a system for determining device attributes based on queries of interest. The system comprises: a processing circuitry; and a memory, the memory containing instructions that, when executed by the processing circuitry, configure the system to: identify a plurality of queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data; determine a plurality of prediction thresholds by applying the machine learning model to a validation data set, wherein each prediction threshold corresponds to a respective output of the machine learning model; and determine, based on the plurality of prediction thresholds and the at least one score output by the machine learning model for the identified queries of interest when applied to the application dataset, at least one device attribute for the device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for securing a network environment by identifying device attributes using queries of interest according to an embodiment.

FIG. 3 is a flowchart illustrating a method for training machine learning models to determine device attributes based on request data according to an embodiment.

FIG. 4 is a schematic diagram of a device attribute identifier according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

It has been identified that device attributes, particularly operating system used by the device, can be identified with a high degree of accuracy using data related to demands for information and, in particular, requests realized as Domain Name System (DNS) queries. More specifically, it has been identified that certain types of devices (e.g., devices having certain operating systems) tend to use at least some queries more than other types of devices. Additionally, it has been identified that the number of times a device sent a particular query correlates strongly to certain device attributes, particularly operating system. In other words, even among devices which send the same DNS queries, devices with certain operating systems tend to send those particular DNS queries more often than devices with other operating systems.

It has further been identified that, although a rules-based mechanism defining certain predetermined patterns to look for when analyzing queries could be used, such a rules-based mechanism would not provide suitable reliability due to variations in patterns that may occur. Specifically, relying on a rules-based mechanism would yield unreliable predictions with low coverage rates. Further, such a rules-based mechanism would require manual definitions, tuning, and maintenance, which would hinder procedural scalability.

Accordingly, the disclosed embodiments provide techniques for identifying device attributes such as operating system using request data such as data in DNS queries. In particular, the disclosed embodiments include techniques for identifying queries of interest among queries and for statistically analyzing the queries of interest in order to determine device attributes. The disclosed embodiments further include techniques for profiling devices using the determined device attributes and for mitigating potential cybersecurity threats using device profiles.

Various disclosed embodiments further provide specific techniques for improving the accuracy of device attribute identification using queries of interest. Such techniques include techniques for normalizing and filtering the data that yield better tuned models when used for training, which in turn improves the accuracy of device attributes determined using outputs of the machine learning models. Some such techniques also filter a larger set of queries into only queries of interest before analyzing the queries of interest, thereby further improving accuracy and efficiency of device attribute identification.

Various disclosed embodiments also provide techniques for improving device attribute identification using machine learning. The disclosed embodiments therefore provide techniques for identifying device attributes using machine learning that demonstrate higher reliability and scalability than manual techniques. Some embodiments improve device attribute identification by using results of device attribute identification using one or more other indicators (i.e., indicators other than web addresses or other contents of queries for computer-identifying information) in order to filter entries from a dataset used for training the model, thereby further improving the accuracy of the machine learning.

In various disclosed embodiments, predictions of device attributes using the trained machine learning model are used to monitor device activity in order to detect abnormal behavior which may be indicative of cybersecurity threats. To this end, the determined device attributes may be added to device profiles for devices and used in accordance with device normal behaviors of devices having certain combinations of device attributes in order to identify potentially abnormal behavior. When abnormal behavior is detected, mitigation actions may be performed in order to mitigate potential cybersecurity threats.

Due to the improved machine learning noted above, using device attributes determined as described herein further allows for more accurately identifying and mitigating potential cybersecurity threats, thereby improving cybersecurity for networks in which such devices operate.

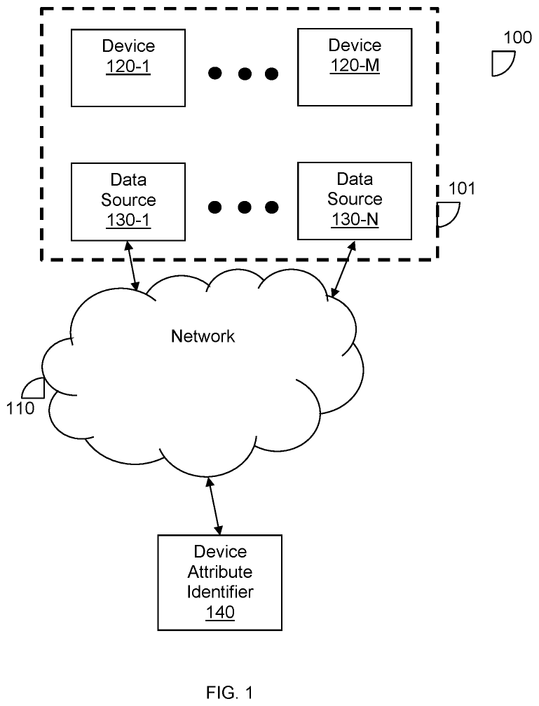

FIG. 1 shows an example network diagram 100 utilized to describe the various disclosed embodiments. In the example network diagram 100, data sources 130-1 through 130-N (hereinafter referred to as a data source 130 or as data sources 130) communicate with a device attribute identifier 140 via a network 110. The network 110 may be, but is not limited to, a wireless, cellular or wired network, a local area network (LAN), a wide area network (WAN), a metro area network (MAN), the Internet, the worldwide web (WWV), similar networks, and any combination thereof.

The data sources 130 are deployed such that they can receive data from systems deployed in a network environment 101 in which devices 120-1 through 120-M (referred to as a device 120 or as devices 120) are deployed and communicate with each other, the data sources 130, other systems (not shown), combinations thereof, and the like. The data sources 130 may be, but are not limited to, databases, network scanners, both, and the like. Data collected by or in the data sources 130 may be transmitted to the device attribute identifier 140 for use in determining device attributes as described herein.

To this end, such data includes at least query data of queries sent by the devices 120. Such query data may include, but is not limited to Domain Name System (DNS) queries or other demands for information identifying specific computers on networks. The contents of such queries may include, for example, a domain name or other address information of a server (not shown) to be accessed. As a non-limiting example, the query data may include a demand for the Internet Protocol (IP) address associated with the domain name “www.website.com.”

Each of the devices 120 may be, but is not limited to, a personal computer, a laptop, a tablet computer, a smartphone, a wearable computing device, or any other device capable of receiving and displaying notifications.

The device attribute identifier 140 is configured to determine device attributes of the devices 120 based on query data obtained from the data sources 130, from the devices 120, or a combination thereof. More specifically, the device attribute identifier 140 is configured to apply one or more machine learning models trained to predict device attributes such as operating systems as described herein.

During a training phase, the machine learning models are trained using training data including training queries. The training queries include DNS queries or other queries requesting information identifying specific computers on networks. As noted above, it has been identified that devices having certain device attributes tend to use at least some queries more than devices having different device attributes and that the number of times a device sent a particular query correlates strongly to certain device attributes, particularly operating system. Accordingly, training the machine learning models using query data allows for identifying device attributes such as operating system with a high degree of accuracy.

Data to be used for training and applying the machine learning models is obtained and processed. The processing may include, but is not limited to, filtering devices (i.e., filtering data associated with respective devices). In particular, device data may be statistically analyzed in order to identify queries of interest, and data for devices which are not queries of interest may be filtered out such that only query of interest data is used for device attribute identification. Various techniques for filtering devices which improve the accuracy of device attribute identification are described further below. The processing may further include splitting the data into disjoint training and validation data sets, where the training data set is used to train the machine learning models and prediction thresholds to be used for determining whether to yield predictions are determined by applying the trained machine learning models to the validation data set.

It should be noted that the device attribute identifier 140 is depicted as being deployed outside of the network environment 101 and the data sources 130 are depicted as being deployed in the network environment 101, but that these depictions do not necessarily limit any particular embodiments disclosed herein. For example, the device attribute identifier 140 may be deployed in the network environment 101, the data sources 130 may be deployed outside of the network environment 101, or both.

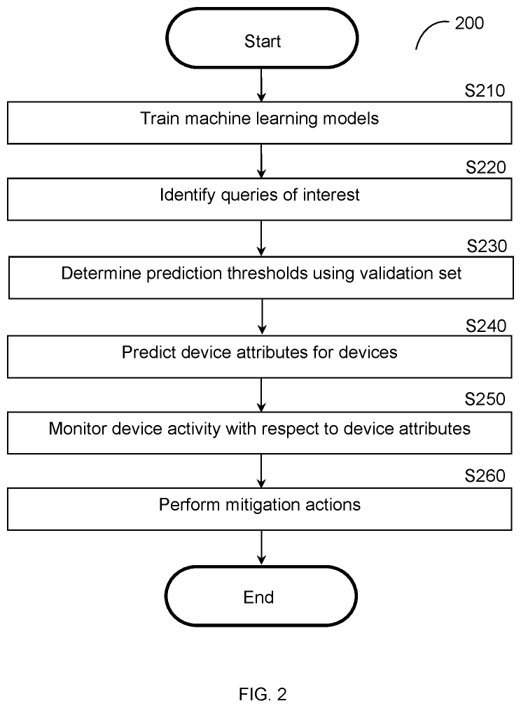

FIG. 2 is an example flowchart 200 illustrating a method for method for securing a network environment by identifying device attributes using queries of interest according to an embodiment. In an embodiment, the method is performed by the device attribute identifier 140, FIG. 1.

At S210, one or more machine learning models are trained to yield predictions of device attributes based on queries for computer-identifying data (e.g., computer address data such as domain names requested via DNS queries). In an embodiment, each machine learning model is a classifier trained to output, for each device, probabilities for respective classes based on queries sent by the device. Each class, in turn, may correspond to a label representing a device attribute (e.g., a particular operating system).

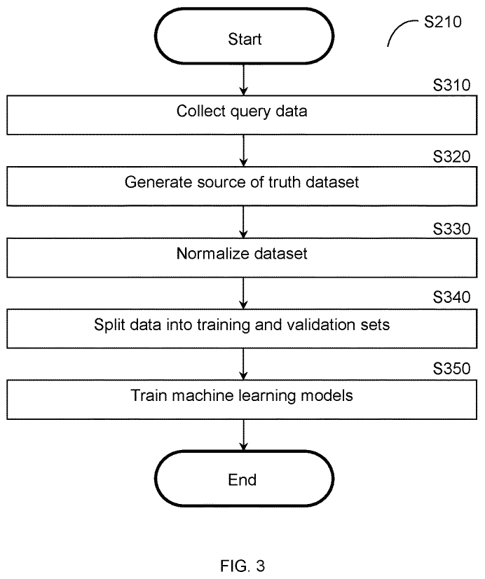

In an embodiment, the machine learning models are trained using a process as depicted with respect to FIG. 3. FIG. 3 is a flowchart S210 illustrating a method for training and validating machine learning models to determine device attributes based on host configuration protocol data according to an embodiment.

At S310, query data related to queries sent by one or more devices is collected. In an embodiment, the query data at least includes queries for computer identifying information such as, but not limited to, DNS queries. To this end, the query data may include uniform resource locators, domain names, or otherwise an address of a resource stored on a system (e.g., a server) accessible via one or more networks. The query data may be read from packets sent from each device.

At S320, a source of truth dataset is generated based on the collected query data. In an embodiment, the source of truth dataset only includes query data of queries sent by devices for which one or more prior device attribute identification analyses yielded a high confidence (e.g., above a threshold). Alternatively or additionally, generating the source of truth dataset may include filtering out data from one or more predetermined blacklisted data sources.

Generating a source of truth dataset based on results from prior device attribute identification analyses allows for refining the model, thereby further improving the accuracy of device attribute identification. In other words, multiple indicators of a particular kind of device attribute may be effectively combined by using results of analysis using one indicator (e.g., contents of host configuration protocols) in order to create a source of truth dataset to further improve device attribute analysis using another indicator (e.g., contents of queries for computer identifiers sent by the device) in a manner that is more accurate than using only one such indicator.

A non-limiting example is described in U.S. patent application Ser. No. 17/655,845, assigned to the common assignee, the contents of which are hereby incorporated by reference. Specifically, the Ser. No. 17/655,845 application discusses a process for identifying device attributes such as operating system based on host configuration protocols and, in particular, the order by which options are requested in Parameter Request List fields. The Ser. No. 17/655,845 application provides techniques which include applying machine learning models trained to output confidence scores corresponding to different potential device attributes. In an example implementation, it may be determined whether the scores output based on options packets for the types of device attributes to be identified are compared to a threshold and data for any devices for which the score is below a threshold may be filtered out, thereby generating the source of truth dataset.

It should also be noted that S320 is described with respect to generating a source of truth dataset by filtering out data for devices based on a single prior device attribute identification using one type of indicator merely for simplicity purposes, and that device attributes may be identified using multiple indicators other than contents of queries for computer identifiers in order to filter out devices without departing from the scope of the disclosure.

At optional S330, the source of truth dataset is normalized. In an embodiment, S330 may include normalizing device attribute identifiers associated with respective portions of data and grouping the source of truth dataset with respect to device attributes. More specifically, data may be grouped with respect to device attributes such that data including device attribute values may be grouped into groups of device data indicating the same device attributes. For example, device data may be grouped with respect to operating systems. Predetermined sets of device attributes known to be related or similar may be mapped. As a non-limiting example, operating system identifiers “Ubuntu” and “Linux” may both be mapped to “Linux” based on a predetermined correspondence between these operating system identifiers. In some embodiments, data may be grouped into an “OTHER” group. For example, the “OTHER” group may include data having device attributes that are absent from a whitelist of device attributes. In this regard, it is noted that the data used by the models as disclosed herein may include the results of the prior device attribute identifications, for example, as labels to be used in a supervised machine learning process.

At S340, the source of truth dataset is split into at least training and validation sets. In an embodiment, S340 may include sampling the data. As a non-limiting example, stratified sampling may be applied such that each class (e.g., each device attribute) is represented in both the training and validation sets in accordance with its overall frequency within the population. Both the training and validation sets at least include features extracted from queries sent by devices, for example, addresses or identifiers of specific computers available via one or more networks extracted from DNS queries sent by devices. The validation set may be used, for example, to determine prediction thresholds as described further below with respect to FIG. 2.

At S350, one or more machine learning models is trained using the training set. In an embodiment, the machine learning models output a probability for each class among multiple potential classes, where each class represents a potential device attribute. For example, a machine learning model may be trained to output respective probabilities for various operating systems.

To this end, each machine learning model is trained to output one or more scores, with each score representing a likelihood that a given device attribute (e.g., operating system) is used by a device that sent a particular query. It should be noted that one machine learning model may output multiple scores, multiple machine learning models may each output a respective score, or a combination thereof, without departing from the scope of the disclosure.

In a further embodiment, each score is generated with respect to a respective statistical property relative to queries sent by the device or by multiple devices represented in the query data. In such an embodiment, scores for different statistical properties calculated for the same device may be aggregated in order to generate a score which represents a prediction of operating system for the device. To this end, in some embodiments, S350 may further include determining such statistical properties and adding the determined statistical properties to the training set for use in training the machine learning models.

The statistical properties may be determined cross-tenant or otherwise across query data from multiple sources, and include predetermined statistical properties known to correlate between those statistical properties and certain device attributes. The statistical properties may include, but are not limited to, how many devices having a given device attribute sent a particular query, how many times that query was sent for devices having a given device attribute, and the like. The statistical properties may be scored using a weighted scoring mechanism, and their respective scores may be utilized to determine if any of the statistical attributes fails to meet a respective threshold by comparing the score to that threshold.

Returning to FIG. 2, at S220, queries of interest are identified from among an application dataset. The application dataset may be, but is not limited to, a dataset including queries sent by devices in one or more network environments. In an example implementation, the application dataset may be the dataset that was split into training and validation sets as discussed above.

In an embodiment, S220 includes filtering non-indicative queries. The non-indicative queries may be, but are not limited to, queries which do not reflect particular types of devices. The non-indicative queries may be discovered using one or more query of interest thresholds. The query of interest thresholds may be predetermined, and may be determined via cross-validation. More specifically, a threshold for device attribute indicator strength may be found using cross-validation, and the score for each statistical property for a given query may be compared to the threshold in order to determine whether the query is a query of interest with respect to each potential device attribute. In an embodiment, if the score for the device attributed predicted for any of the statistical properties of a given query is below the respective threshold, the query may be filtered out as not being a query of interest.

At S230, one or more prediction thresholds are determined using the validation set. In an embodiment, S230 includes applying the trained machine learning models to the validation set. As noted above, when applied, each model outputs one or more scores representing likelihoods of respective device attributes. The models may further output a predicted device attribute, e.g., the device attribute having the highest score. Using at least the scores output by the models when applied to the validation set, statistical metrics for each label (i.e., each potential device attribute) may be determined with respect to multiple potential thresholds. As a non-limiting example, such metrics may include precision and recall. Based on the metrics, an optimal threshold may be determined for each label (i.e., each device attribute value representing a respective device attribute).

At S240, based on the outputs of the machine learning models applied to the validation set, one or more device attribute predictions are determined for each device. More specifically, scores output for each query of interest may be aggregated in order to determine predictions for each device. A corresponding probability may also be determined for each prediction. Using the predictions, probabilities, or both, one or more device attributes of each device are predicted. To this end, in an embodiment, S240 further includes applying prediction thresholds to the scores output for the queries of interest in order to determine whether each score meets or exceeds the respective prediction threshold, and only scores above their respective prediction thresholds are utilized to determine device predictions. In other words, a particular prediction is only yielded for a device when the score for that device attribute is equal to or greater than the prediction threshold for that type of device attribute.

At S250, device activity of one or more devices is monitored for abnormal behavior based on the determined device attributes.

In an embodiment, S250 includes adding the device attributes to respective profiles of devices for which the device attributes were determined and monitoring the activity of those devices based on their respective profiles. In such an embodiment, one or more policies define allowable behavior for devices having different device attributes such that, when a device having a certain device attribute or combination of device attributes deviates from the behavior indicated in the policy for that device attribute, the device's current behavior can be detected as abnormal and potentially requiring mitigation. The policy may be defined based on previously determined profiles including known device behavior baselines for respective devices. In a further embodiment, normal behavior patterns with respect to certain combinations of device attributes may be defined manually or learned using machine learning, and S250 may include monitoring for deviations from these normal behavior patterns.

At S260, one or more mitigation actions are performed in order to mitigate potential cyberthreats detected as abnormal behavior at S240. The mitigation actions may include, but are not limited to, severing communications between a device and one or more other devices or networks, generating an alert, sending a notification (e.g., to an administrator of a network environment), restricting access by the device, blocking devices (e.g., by adding such devices to a blacklist), combinations thereof, and the like. In some embodiments, devices having certain device attributes may be blacklisted such that devices having those device attributes are disallowed, and the mitigation actions may include blocking or severing communications with devices having the blacklisted device attributes.

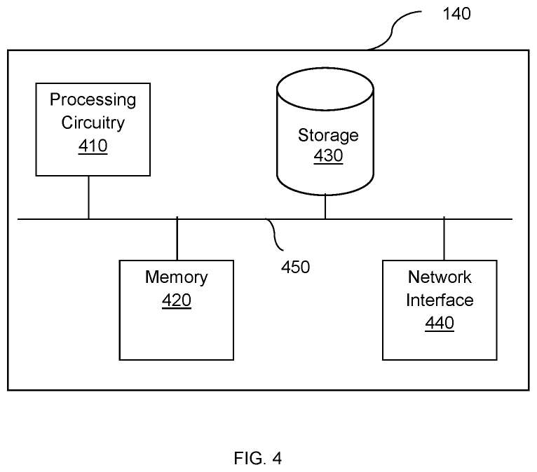

FIG. 4 is an example schematic diagram of a device attribute identifier 140 according to an embodiment. The device attribute identifier 140 includes a processing circuitry 410 coupled to a memory 420, a storage 430, and a network interface 440. In an embodiment, the components of the device attribute identifier 140 may be communicatively connected via a bus 450.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 420 may be volatile (e.g., random access memory, etc.), non-volatile (e.g., read only memory, flash memory, etc.), or a combination thereof.

In one configuration, software for implementing one or more embodiments disclosed herein may be stored in the storage 430. In another configuration, the memory 420 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 410, cause the processing circuitry 410 to perform the various processes described herein.

The storage 430 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 440 allows the device attribute identifier 140 to communicate with, for example, the data sources 130, FIG. 1.

It should be understood that the embodiments described herein are not limited to the specific architecture illustrated in FIG. 4, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining device attributes based on host configuration protocols, comprising:
identifying a plurality of queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data;
determining a plurality of prediction thresholds by applying the machine learning model to a validation data set, wherein each prediction threshold corresponds to a respective output of the machine learning model; and
determining, based on the plurality of prediction thresholds and the at least one score output by the machine learning model for the identified queries of interest when applied to the application dataset, at least one device attribute for the device.

2. The method of claim 1, wherein the at least one score output by the machine learning model when applied to the application dataset is at least one first score, further comprising:
applying the machine learning model to the validation dataset in order to output at least one second score for each of a plurality of potential device attribute labels;
determining a set of statistical metrics for each of the plurality of potential device attribute labels based on the at least one second score with respect to a plurality of potential thresholds for the potential device attribute label; and
selecting a threshold from among the plurality of potential thresholds for each potential device attribute label based on the set of statistical metrics determined for each of the plurality of potential device attribute labels, wherein the plurality of prediction thresholds includes each selected threshold.

3. The method of claim 1, further comprising:
splitting the application data set into a training data set and the validation data set, wherein the machine learning model is trained using the training data set.

4. The method of claim 1, further comprising:
generating a source of truth dataset by filtering query data from a plurality of devices, wherein the source of truth dataset includes query data from a subset of the plurality of devices; and
training the machine learning model using features extracted from the source of truth dataset.

5. The method of claim 4, wherein queries for computer addresses are a first type of indicator of device attributes, wherein generating the source of truth dataset further comprises:
predicting at least one device attribute for each of the plurality of devices based on a second type of indicator of device attributes, wherein each device attribute predicted based on the second type of indicator has a corresponding confidence score representing a likelihood that the prediction is accurate;
comparing the confidence score for each device attribute predicted based on the second type of indicator to a respective threshold, wherein the subset of the plurality of devices is determined based on the comparison.

6. The method of claim 1, wherein the at least one device attribute determined for the device includes an operating system used by the device.

7. The method of claim 1, further comprising:
monitoring activity of the first device with respect to at least one policy corresponding to the identified at least one device attribute of the first device; and
performing at least one mitigation action based on the monitored activity.

8. A non-transitory computer readable medium having stored thereon instructions for causing a processing circuitry to execute a process, the process comprising:
identifying a plurality of queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data;
determining a plurality of prediction thresholds by applying the machine learning model to a validation data set, wherein each prediction threshold corresponds to a respective output of the machine learning model; and
determining, based on the plurality of prediction thresholds and the at least one score output by the machine learning model for the identified queries of interest when applied to the application dataset, at least one device attribute for the device.

9. A system for determining device attributes based on host configuration protocols, comprising:
a processing circuitry; and
a memory, the memory containing instructions that, when executed by the processing circuitry, configure the system to:
identify a plurality of queries of interest among an application data set including queries for computer address data sent by at least one device, wherein each query of interest meets a respective threshold of at least one threshold for each of the at least one score output by a machine learning model, wherein the machine learning model is trained to output at least one score with respect to statistical properties of queries for computer address data;
determine a plurality of prediction thresholds by applying the machine learning model to a validation data set, wherein each prediction threshold corresponds to a respective output of the machine learning model; and
determine, based on the plurality of prediction thresholds and the at least one score output by the machine learning model for the identified queries of interest when applied to the application dataset, at least one device attribute for the device.

10. The system of claim 9, wherein the at least one score output by the machine learning model when applied to the application dataset is at least one first score, wherein the system is further configured to:
apply the machine learning model to the validation dataset in order to output at least one second score for each of a plurality of potential device attribute labels;
determine a set of statistical metrics for each of the plurality of potential device attribute labels based on the at least one second score with respect to a plurality of potential thresholds for the potential device attribute label; and
select a threshold from among the plurality of potential thresholds for each potential device attribute label based on the set of statistical metrics determined for each of the plurality of potential device attribute labels, wherein the plurality of prediction thresholds includes each selected threshold.

11. The system of claim 9, wherein the system is further configured to:
split the application data set into a training data set and the validation data set, wherein the machine learning model is trained using the training data set.

12. The system of claim 9, wherein the system is further configured to:
generate a source of truth dataset by filtering query data from a plurality of devices, wherein the source of truth dataset includes query data from a subset of the plurality of devices; and
train the machine learning model using features extracted from the source of truth dataset.

13. The system of claim 12, wherein queries for computer addresses are a first type of indicator of device attributes, wherein the system is further configured to:
predict at least one device attribute for each of the plurality of devices based on a second type of indicator of device attributes, wherein each device attribute predicted based on the second type of indicator has a corresponding confidence score representing a likelihood that the prediction is accurate;
compare the confidence score for each device attribute predicted based on the second type of indicator to a respective threshold, wherein the subset of the plurality of devices is determined based on the comparison.

14. The system of claim 9, wherein the at least one device attribute determined for the device includes an operating system used by the device.

15. The system of claim 9, wherein the system is further configured to:
monitor activity of the first device with respect to at least one policy corresponding to the identified at least one device attribute of the first device; and
perform at least one mitigation action based on the monitored activity.
